(19) United States
(12) Patent Application Publication
(10) Pub. No.: US 2013/0084922 A1
(43) Pub. Date: Apr. 4, 2013

(54) Portable Electronic Device and the Mode Switching Method Thereof

(71) Applicant: High Tech Computer, Corp., Taoyuan City (TW)

(72) Inventors: Ching-Tung LIU, Taoyuan City (TW); Yu-Peng LAI, Taoyuan City (TW)

(73) Assignee: HIGH TECH COMPUTER, CORP., Taoyuan City (TW)

(21) Appl. No.: 13/686,042

(22) Filed: Nov. 27, 2012

Related U.S. Application Data
(62) Division of application No. 12/458,524, filed on Jul. 15, 2009.

(30) Foreign Application Priority Data
Jul. 16, 2008 (TW) 97126888

(51) Int. Cl. H04W 88/02; H04W 52/02

(52) U.S. Cl. CPC H04W 88/02; H04W 52/02
USPC 455/566

(57) ABSTRACT

The present invention relates to a portable electronic device which can be switched between a first mode and a second mode. The portable electronic device comprises a first sensor to detect a touch on the portable electronic device and generate a first signal based on such touch, a second sensor to detect a movement of the portable electronic device and generate a second signal based on such movement, and a processing unit which electrically connects the first sensor and the second sensor. When the portable electronic device is in the first mode, the processing unit switches the portable electronic device to the second mode based on the first and second signals. In addition, the present invention provides a mode switching method that enables the portable electronic device to determine whether to enter or exit from the sleep mode.

### CROSS-REFERENCE TO RELATED APPLICATIONS

This application is a divisional application of pending U.S. application Ser. No. 12/458,524, filed Jul. 15, 2009 (wherein the entire disclosure of the pending, prior application is incorporated herein by reference).

### BACKGROUND OF THE INVENTION

1. Field of the Invention

The present invention relates to a mode switching method for portable electronic device, more particularly, to a portable electronic device and its mode switching method, in which the mode is switched between a first mode and a second mode based on the signals generated by two types of sensors.

2. Description of the Related Art

Portable electronic devices such as mobile phones and PDAs are usually equipped with two modes, a sleep mode and an operating mode. Such portable electronic device will remain in operating mode when its functions and applications are operated by the user and will enter sleep mode to extend its battery life after being idle for a certain period of time.

For a conventional portable electronic device, the switch between sleep mode and operating mode usually relies on a predetermined period of time set with software. Where a predetermined period of inactivity has elapsed, the portable electronic device will enter sleep mode and the user must manually press a default key to switch the portable electronic device to operating mode when s/he wants to operate it.

As the mode switching method of the conventional portable electronic device is not based on the user's actions, the device will not enter sleep mode immediately after the user stops using it, and will thus cause unnecessary power consumption during the predetermined period of time. Moreover, prior to the portable electronic device resuming operating mode, the user is required to perform an additional step of pressing a key to have the portable electronic device exit from sleep mode, thus resulting in unnecessary operation for the user. To address the aforementioned drawbacks, the present invention provides a portable electronic device and the mode switching method thereof designed based on the user's actions to reduce unnecessary power consumption and simplify the operation procedure.

### SUMMARY OF THE INVENTION

An object of the present disclosure is to provide a portable electronic device that switches between different modes of operation based on the user's actions.

Another object of the present disclosure is to provide a mode switching method for the portable electronic device designed based on the user's actions.

To achieve the aforementioned objects, the present disclosure provides a portable electronic device which can be switched between a first mode and a second mode. The portable electronic device comprises a first sensor to detect a touch on the portable electronic device and generate a first signal based on such touch, a second sensor to detect a movement of the portable electronic device and generate a second signal based on such movement, and a processing unit which electrically connects the first sensor and the second sensor. When the portable electronic device is in the first mode, the processing unit will switch the portable electronic device to the second mode based on the first and second signals.

According to one embodiment of the present disclosure, the aforementioned first and second modes may be sleep mode and operating mode respectively, and the portable electronic device consumes less power in the first mode than in the second mode.

According to one embodiment of the present disclosure, the aforementioned first sensor is a capacitive touch sensor disposed at one side of the portable electronic device and/or on the surface opposite to the surface of the display and the second sensor is an accelerometer.

To achieve the aforementioned objects, the present disclosure further provides a mode switching method for a portable electronic device which can be switched between a first mode and a second mode. The mode switching method comprises the following steps: detecting a touch on the portable electronic device and generating a first signal based on such touch; detecting a movement of the portable electronic device and generating a second signal based on such movement; and switching the portable electronic device to the second mode based on the first and second signals when the portable electronic device is in the first mode.

According to one embodiment of the present disclosure, the aforementioned first mode and second mode are sleep mode and operating mode respectively; a capacitive touch sensor is used to detect the touch on the portable electronic device; and an accelerometer is used to detect a movement of the portable electronic device.

According to one embodiment of the present disclosure, the aforementioned mode switching method further comprises the step of initiating the detection of the portable electronic device's movement based on the first signal.

### BRIEF DESCRIPTION OF THE DRAWINGS

FIG. 1 is a three-dimensional view showing the portable electronic device of the present invention.

FIG. 2 is a schematic view showing the rear portion of the portable electronic device of the present invention.

FIG. 3A is a system block diagram of the portable electronic device according to the first embodiment of the present invention.

FIG. 3B is a system block diagram of the portable electronic device according to the second embodiment of the present invention.

FIG. 4 is a flow chart showing the steps of determining whether to switch from sleep mode to operating mode according to the method of the present invention.

FIG. 5 is a flow chart showing the steps of determining whether to switch from operating mode to sleep mode according to the method of the present invention.

FIG. 6 is another flow chart showing the steps of determining whether to switch from operating mode to sleep mode according to the method of the present invention.

### DETAILED DESCRIPTION OF THE PREFERRED EMBODIMENTS

The techniques, functions and features of the present invention will be described more fully hereinafter with the preferred embodiments of the present invention and the accompanying drawings.

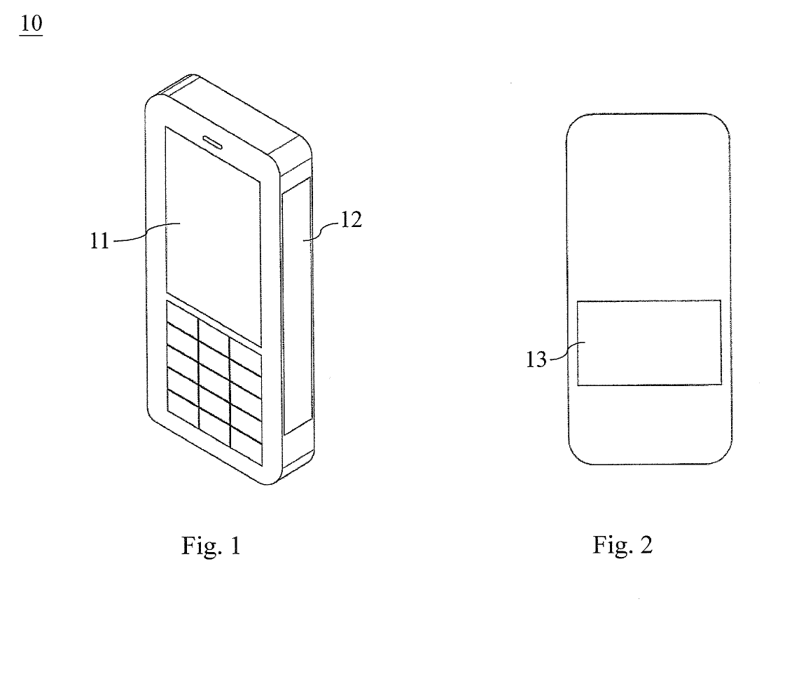

FIG. 1 is a three-dimensional view showing a portable electronic device 10 of the present invention. According to the embodiment of the present invention, the portable electronic device 10 may be any portable electronic device which performs the present invention, including but not limited to a mobile phone, PDA, digital camera, etc. In the embodiment, the portable electronic device 10 is a mobile phone. The portable electronic device 10 includes an LCD display 11 and a touch sensor 12 which is mounted on at least one of the two adjoining sides of the LCD display 11. Such touch sensor 12 detects whether or not the portable electronic device 10 is being held by a user. In addition, the touch sensor 12 may be a capacitive touch sensor that detects whether the portable electronic device 10 is being held by a user.

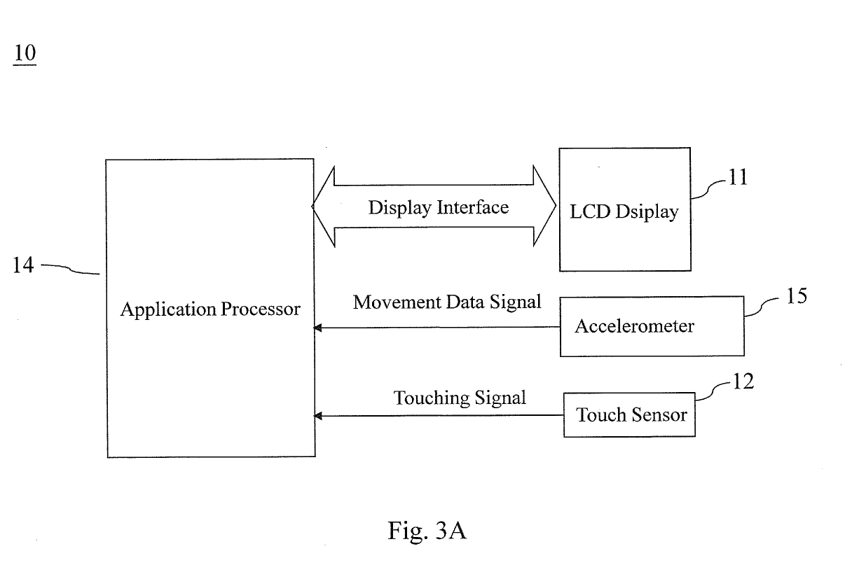

FIG. 2 is a schematic view showing the rear portion of the portable electronic device of the present invention. As shown in FIG. 2, a touch sensor 13 positioned at the rear portion opposite to the LCD display 11 is further included to more accurately detect the user's grip on the portable electronic device 10. As such, the portable electronic device 10 detects whether it is being held by the user through the touch sensors 12 and 13.

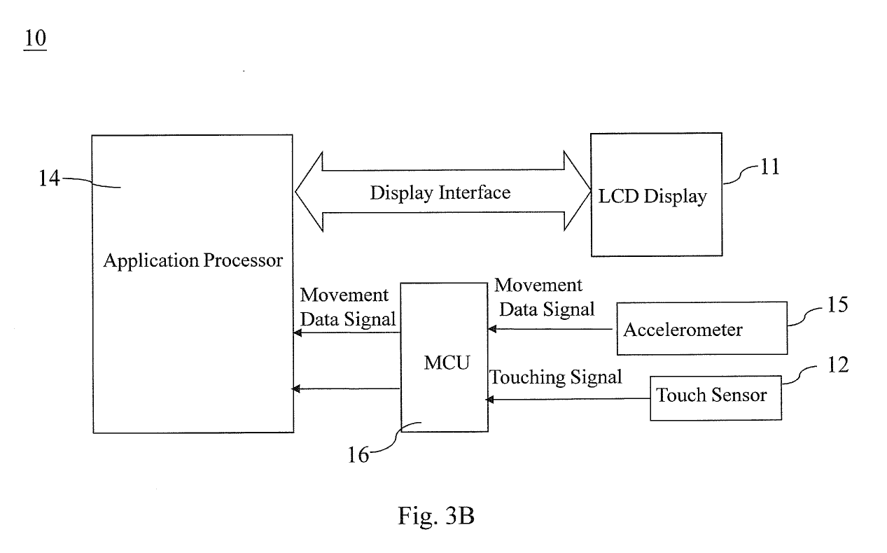

FIG. 3A is a system block diagram of the portable electronic device 10 according to the first embodiment of the present invention. In the first embodiment, the portable electronic device 10 can switch between an operating mode and a sleep mode and comprises an application processor 14 and an input interface (not shown). When the portable electronic device 10 is in the operating mode, the application processor 14 can execute applications and display information on the LCD display 11 via the display interface. When the portable electronic device 10 enters the sleep mode, the operation of the application processor 14 consumes relatively less power and the LCD display 11 is turned off. The portable electronic device 10 consumes less power in the sleep mode than in the operating mode.

The application processor 14 receives at least one touching signal from at least one of the touch sensors 12 and 13 and a movement data signal from an accelerometer 15. The application processor 14 then analyzes the touching signal and the movement data signal and switches the portable electronic device 10 to one of the operating mode and the sleep mode based on the analyzed results. The movement data signal of the accelerometer 15 includes a value of gravitational acceleration (value g) of the portable electronic device 10 in a three dimensional space (x-, y- and z-axes).

FIG. 3B is a system block diagram of the portable electronic device 10 according to the second embodiment of the present invention. In this embodiment, the portable electronic device 10 can switch between an operating mode and a sleep mode, and comprises an application processor 14, a micro-controller (MCU) 16 and an input interface (not shown). When the portable electronic device 10 is in the operating mode, the application processor 14 can execute applications and display information on an LCD display 11 via the display interface. When the portable electronic device 10 enters the sleep mode, the operation of the application processor 14 consumes relatively less power and the LCD display 11 is turned off.

In both of the operating mode and the sleep mode, the MCU 16 will monitor at least one of the touch sensor 12 and the accelerometer 15. The MCU 16 also analyzes the touching signal generated by the touch sensor 12 and the movement data signal generated by the accelerometer 15, and sends an interruption signal to the application processor 14 based on the analyzed results. Based on the interruption signal, the application processor 14 will then execute the interruption program to switch the portable electronic device 10 from the operating/sleep mode to the sleep/operating mode accordingly.

The MCU 16 generates an interruption signal to perform different tasks in various embodiments. The following description lists a number of situations in which an interruption signal is generated. For example, in the sleep mode, when the MCU 16 analyzes a touching signal generated when the touch sensor 12 is touched (i.e. the user is holding the portable electronic device 10), an interruption signal will be generated to enable the application processor 14 to read the movement data signal from the accelerometer 15 via the MCU 16. In the operating mode, when the MCU 16 determines that the change of the value g of the accelerometer 15 falls within a predetermined range, an interruption signal will be generated to cause the application processor 14 to execute certain procedures. In the operating mode, when the MCU 16 determines that the touching signal of the touch sensor 12 is disenabled or not actuated (i.e. the portable electronic device 10 is no longer held by the user), an interruption signal will be generated to cause the application processor 14 to execute certain procedures.

According to the first and second embodiments described above, the portable electronic device 10 of the present invention utilizes two types of sensors to detect the user's act of gripping the portable electronic device 10. More specifically, the touch sensors (or capacitive touch sensors) 12 and 13 are utilized to detect whether the portable electronic device 10 is being held by the user and, in the affirmative, the accelerometer 15 will start to detect the movement of the portable electronic device 10 in the three dimensional space to determine whether the portable electronic device 10 is “being lifted” or “being put down”. More particularly, only when the signal generated by the first sensor satisfies a predetermined condition or range, the present invention determines whether the signal generated by the second sensor satisfies another predetermined condition or range. The portable electronic device 10 will be switched between operating mode and sleep mode based on the analyzed results of the signal generated by the second sensor.

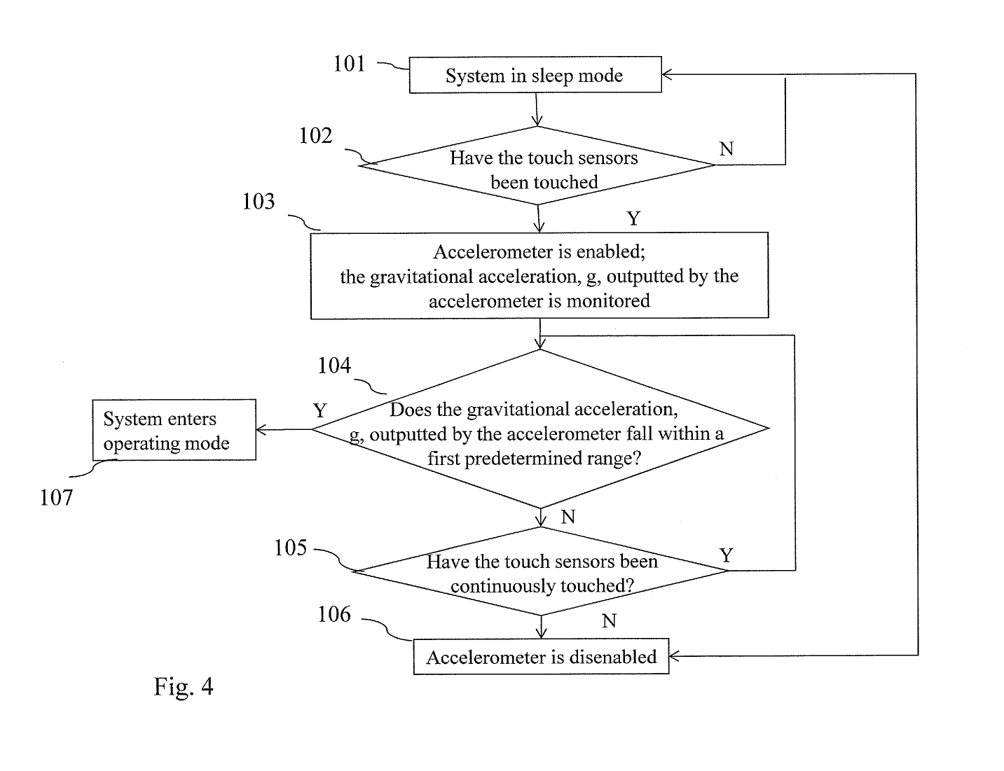

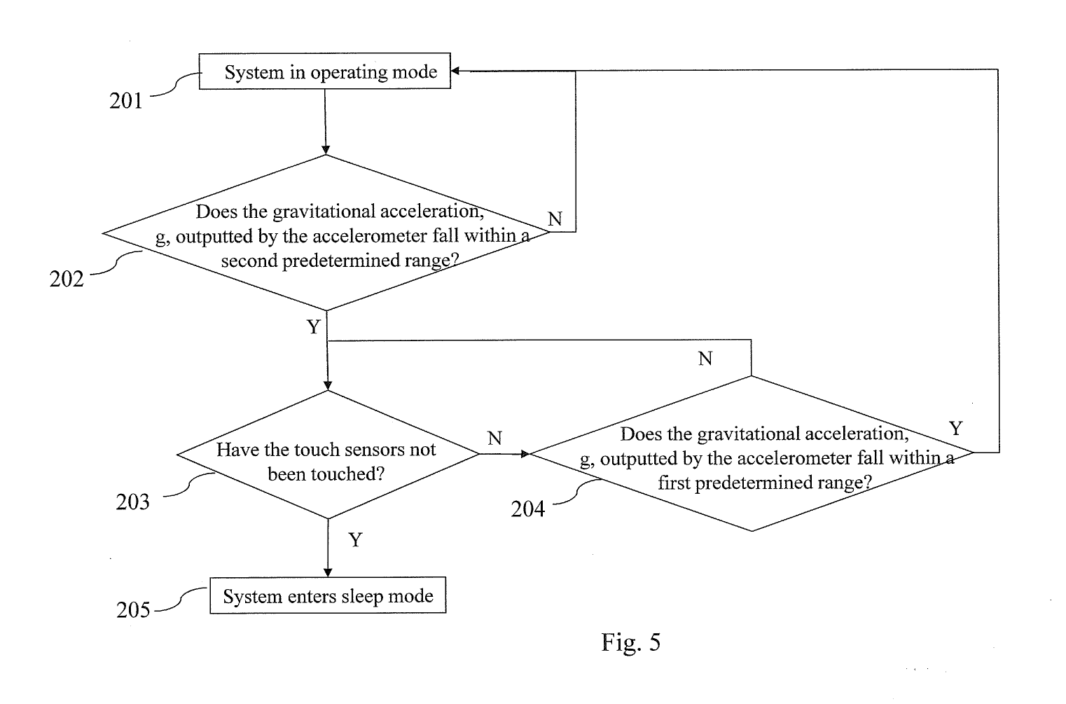

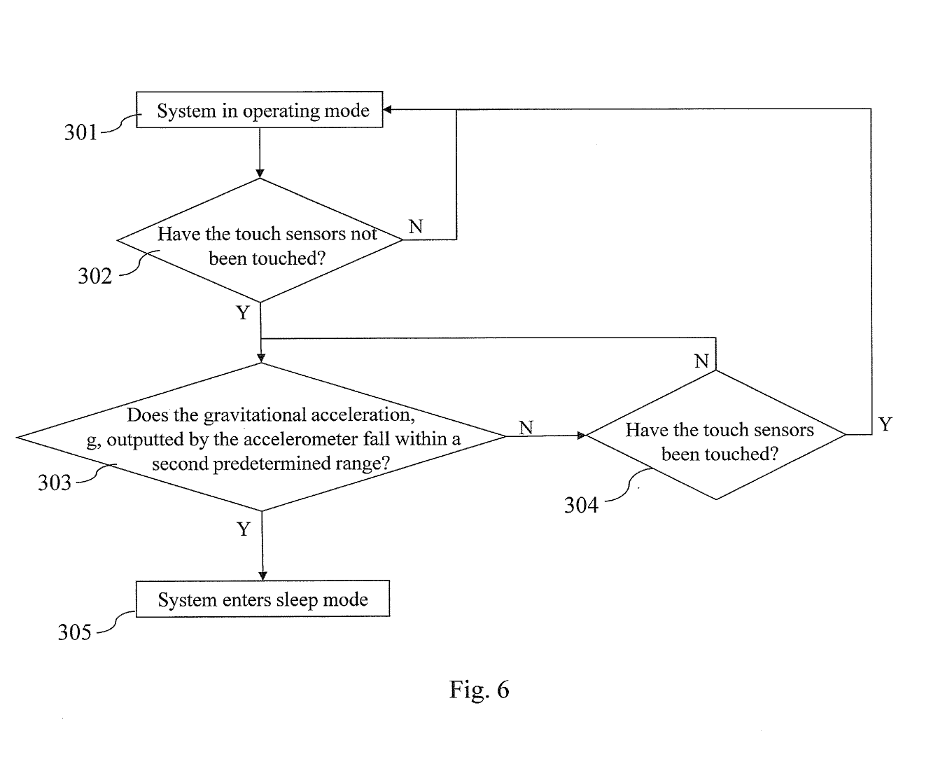

As depicted in the embodiments shown in FIG. 3A and FIG. 3B, the portable electronic device 10 of the present invention utilizes two types of sensors to detect the user's behavior of operating the portable electronic device 10 to determine the mode thereof. FIG. 4 is a flow chart showing the steps of determining whether to enter operating mode from sleep mode. As shown in FIG. 4, the portable electronic device 10 first reads the touching signal generated by the touch sensor and then enables the accelerometer 15 to determine whether to switch modes. FIG. 5 and FIG. 6 are two flow charts showing the steps of determining whether to enter sleep mode from operating mode. As shown in FIG. 5, the portable electronic device 10 may read and analyze the value g of the accelerometer 15 before determining whether to enter sleep mode based on the touching signals of the touch sensors 12 and 13. Alternatively, as shown in FIG. 6, the portable electronic device 10 may read and analyze the touching signal generated by the touch sensors 12 and 13 before determining whether to enter sleep mode based on the value g of the accelerometer 15. Each flow chart will be further described in detail as follows.

FIG. 4 is a flow chart showing the method of determining whether to enter operating mode from sleep mode. When the portable electronic device 10 is in sleep mode (Step 101), the application processor 14 or the MCU 16 will monitor whether the touch sensors 12 and 13 have been touched or actuated (Step 102) and will read and analyze the touching signal to determine whether the portable electronic device has been gripped or touched by the user accidentally. If the touch sensors 12 and 13 are not being touched or if it is determined that the touching signal is caused due to an accident touch, then the portable electronic device 10 will remain in sleep mode (Step 101). If the touch sensors 12 and 13 are being touched or if it is determined that the touching signal is correct, it means that the user is holding the portable electronic device 10 and the application processor 14 will execute the interruption program to perform the following steps. Alternatively, the MCU 16 may send the application processor 14 an interruption signal to execute the interruption program to perform the following steps.

After the user's grip on the portable electronic device 10 is confirmed, the application processor 14 or the MCU 16 will enable the accelerometer 15 to detect the movement of the portable electronic device 10 and monitor the change of the value g, gravitational acceleration, generated by the accelerometer 15 (Step 103). The value g represents the gravitational acceleration in the three dimensional space. When the portable electronic device 10 is being held and a movement is detected, the application processor 14 or the MCU 16 will continuously reads the value g, generated by the accelerometer 15, to determine whether the value g falls within a first predetermined range (Step 104). The first predetermined range represents the range corresponding to changes in the value g which is generated by the accelerometer 15 when the portable electronic device 10 is “being lifted”. By conducting prior experiments to record the change in the value g when the portable electronic device 10 is being lifted, the first predetermined range may be established and stored in the database of the portable electronic device 10.

As the speed at which the portable electronic device 10 is being lifted varies from person to person, the confidence level that the change in the value g outputted by the accelerometer 15, falls within the range of change corresponding to the portable electronic device 10 being lifted can be calculated via different sampling time. Once the confidence level reaches a threshold, thereby indicating that the user's act of lifting the portable electronic device 10 is confirmed and the analyzed result is reliable, then the system of the portable electronic device 10 will enter operating mode (Step 107). In addition, if the change in the value g outputted by the accelerometer 15, corresponds to the trend of change in the value g stored in the database (established through the “lifting” of the portable electronic device 10), the user's act of lifting the portable electronic device 10 can also be confirmed. Therefore, when the process proceeds to Step 107, the user's grip on the portable electronic device 10 would have been confirmed and the user can simply lift the portable electronic device 10 to have the system enter operating mode without pressing any key.

When the application processor 14 or the MCU 16 determines that the value g outputted by the accelerometer 15, does not fall within the first predetermined range (Step 104), that is, the portable electronic device 10 is not being lifted, the application processor 14 or the MCU 16 will keep monitoring the touch sensors 12 and 13 to determine whether such sensors continue to be touched (Step 105). If the touch sensors 12 and 13 are continuously touched, then the user continues to hold the portable electronic device 10 and the application processor 14 or the MCU 16 will continue to read the value g outputted by the accelerometer 15, to determine whether the change in the value g outputted by the accelerometer 15, falls within the first predetermined range (Step 104). If the touch sensors 12 and 13 are not being touched, then the user has loosened his/her grip on the portable electronic device 10 before lifting it. The application processor 14 or the MCU 16 will then interrupt the process of determining whether the value g outputted by the accelerometer 15, falls within the first predetermined range and disenable the accelerometer 15 (Step 106). The portable electronic device 10 will then remain in sleep mode (Step 101) until the touch sensors 12 and 13 are once again touched or the user once again grips the portable electronic device 10.

In a further embodiment of the present invention, when the application processor 14 or the MCU 16 enables the accelerometer 15 and monitors its movement data signal (Step 103), the process proceeds to a loop between Step 104 and Step 105. At the same time, the application processor 14 or the MCU 16 will start a timer and, within a predetermined period of time, will read the gravitational acceleration g outputted by the accelerometer 15, to determine whether the portable electronic device 10 is being lifted. If the application processor 14 or the MCU 16 is unable to determine, within the predetermined period of time, that the portable electronic device 10 is being lifted based on the value g outputted by the accelerometer 15, to switch the system to operating mode, then the application processor 14 or the MCU 16 will cause the portable electronic device 10 to enter operating mode once such predetermined period of time has elapsed. Therefore, forcing the system to enter operating mode after the predetermined period of time has elapsed by means of the timer prevents the system from being trapped in the loop between Step 104 and Step 105. Moreover, if the application processor 14 or the MCU 16 determines, within such predetermined period of time, that the touch sensors 12 and 13 are no longer being touched, the accelerometer 15 will then be disenabled (Step 106) and the portable electronic device 10 will remain in sleep mode (Step 101).

Both FIG. 5 and FIG. 6 show the method of determining whether to enter sleep mode from operating mode, but the steps illustrated in the two drawings are slightly different in terms of order. In the flow chart shown in FIG. 5, the value g of the accelerometer 15 is read before determining whether the touch sensors 12 and 13 detect any touch on the portable electronic device 10. In the flow chart shown in FIG. 6, whether the touch sensors 12 and 13 detect any touch on the portable electronic device 10 is determined before reading the value g of the accelerometer 15. With reference to FIG. 5, when the portable electronic device 10 is in operating mode (Step 201), the application processor 14 or the MCU 16 monitors the movement data signal of the accelerometer 15 continuously or regularly at a predetermined period of time, and determines whether the value g outputted by the accelerometer 15, falls within a second predetermined range (Step 202). The second predetermined range represents the range corresponding to changes in the value g generated by the accelerometer 15 when the portable electronic device 10 is “being put down”. By conducting prior experiments to record the change in the value g when the portable electronic device 10 is being put down, the second predetermined range may be established and stored in the database of the portable electronic device 10.

As the speed at which the portable electronic device 10 is being put down varies from person to person, the confidence level that the change in the value g outputted by the accelerometer 15, falls within the range of change corresponding to the portable electronic device 10 being put down can be calculated via different sampling time. Once the confidence level reaches a threshold, the user's act of putting down the portable electronic device 10 is confirmed and the analyzed result is reliable. In addition, if the change in the value g outputted by the accelerometer 15, corresponds to the trend of change in the value g stored in the database (established through the “putting down” of the portable electronic device 10), the user's act of putting down the portable electronic device 10 can also be confirmed. When the application processor 14 or the MCU 16 determines that the value g outputted by the accelerometer 15, does not fall within the second predetermined range (Step 202), that is, the portable electronic device 10 has not been put down, the portable electronic device 10 will remain in operating mode (Step 201).

If the application processor 14 or the MCU 16 determines that the value g outputted by the accelerometer 15, falls within the second predetermined range, the application processor 14 will execute the interruption program (alternatively, the MCU 16 may generate an interruption signal to cause the application processor 14 to execute the interruption program) and further monitor the touch sensors 12 and 13 to determine whether they are not being touched (Step 203). If the application processor 14 or the MCU 16 reads the touching signal and determines that the user has put down the portable electronic device 10, the system of the portable electronic device 10 will enter sleep mode (Step 205). As such, when the process proceeds to Step 205, the user's act of putting down the portable electronic device 10 would have been confirmed and the system will enter sleep mode immediately without having to wait for a predetermined period of time, thus reducing power consumption.

Where the application processor 14 or the MCU 16 determines that the user is still holding the portable electronic device 10, that is, the touch sensors are touched continuously, the application processor 14 or the MCU 16 will determine whether the value g outputted by the accelerometer 15, falls within the first predetermined range (Step 204). In the affirmative, the portable electronic device 10 has been lifted again before the user loosened his/her grip on it and the portable electronic device 10 will therefore remain in operating mode (Step 201). If the value g does not fall within the first predetermined range, the application processor 14 or the MCU 16 will continue to monitor the touch sensors 12 and 13 to determine whether they are not being touched (Step 203) to confirm whether the portable electronic device 10 has been put down.

In the further embodiment of the present invention, the process will proceed to a loop between Step 203 and Step 204 after the application processor 14 or the MCU 16 determines that the value g outputted by the accelerometer 15, falls within the second predetermined range. At the same time, the application processor 14 or the MCU 16 will start a timer and monitor the touch sensors 12 and 13 to determine, within a predetermined period of time, whether the two sensors 12 and 13 are not being touched (Step 203). If the application processor 14 or the MCU 16 is unable to determine, within such predetermined period of time, whether the user has loosened his/her grip on the portable electronic device 10 based on the touching signal generated by the touch sensors 12 and 13 and to switch the system to sleep mode (Step 205), then the application processor 14 or the MCU 16 will cause the portable electronic device 10 to enter sleep mode once such predetermined period of time has elapsed. Therefore, forcing the system to enter sleep mode after the predetermined period of time has elapsed by means of the timer can prevent the system from being trapped in the loop between Step 203 and Step 204. Moreover, if the application processor 14 or the MCU 16 determines, within such predetermined period of time, that the value g outputted by the accelerometer 15, falls within the first predetermined range (Step 204), then the portable electronic device 10 has again been lifted and the portable electronic device 10 will remain in operating mode (Step 201).

In reference to FIG. 6, when the portable electronic device 10 is in operating mode (Step 301), the application processor 14 or the MCU 16 will monitor the touch sensors 12 and 13 to determine whether they are not being touched (Step 302). If the application processor 14 or the MCU 16 reads the touching signal and determines that the user is still holding the portable electronic device 10, the portable electronic device 10 will remain in operating mode (Step 301). If the application processor 14 or the MCU 16 determines that the user has likely loosened his/her grip on the portable electronic device 10 (whereas in fact the touch sensors 12 and 13 may not be touched by reason of different ways of holding the portable electronic device 10), then the application processor 14 will execute the interruption program (alternatively, the MCU 16 may generate an interruption signal to cause the application processor 14 to execute the interruption program) and further monitor the value g comprised in the movement data signal of the accelerometer 15 (Step 303). If the application processor 14 or the MCU 16 determines that the value g outputted by the accelerometer 15, falls within the second predetermined range, then the user's act of putting down the portable electronic device 10 is confirmed and the system of the portable electronic device 10 will enter sleep mode (Step 305).

The application processor 14 or the MCU 16 will monitor the touch sensors 12 and 13 to determine whether they are being touched (Step 304) before confirming that the portable electronic device 10 has not been put down, that is, the value g of the accelerometer 15 has not yet fallen within the second predetermined range. If the application processor 14 or the MCU 16 determines that the touch sensors 12 and 13 are being touched, then the user is again holding the portable electronic device 10 before putting it down and the portable electronic device 10 will therefore remain in operating mode (Step 301). If the application processor 14 or the MCU 16 determines that the touch sensors 12 and 13 are not being touched, the application processor 14 or the MCU 16 will continue to monitor the value g comprised in the movement data signal of the accelerometer 15 to determine whether the portable electronic device 10 has been put down.

In the further embodiment of the present invention, the process will proceed to a loop between Step 303 and Step 304 after the application processor 14 or the MCU 16 determines that the touch sensors 12 and 13 have not been touched. At the same time, the application processor 14 or the MCU 16 will start a timer and constantly monitor, within a predetermined period of time, the value g comprised in the movement data signal of the accelerometer 15 (Step 303) in order to determine whether the portable electronic device 10 has been put down. If the application processor 14 or the MCU 16 is unable to determine, within such predetermined period of time, whether the portable electronic device 10 is being put down based on the movement data signal of the accelerometer 15 and to switch the system to sleep mode (Step 305), then the application processor 14 or the MCU 16 will cause the portable electronic device 10 to enter sleep mode. As such, forcing the system to enter sleep mode after the predetermined period of time has elapsed by means of the timer can prevent the system from being trapped in the loop between Step 303 and Step 304. In addition, if the application processor 14 or the MCU 16 determines, within such predetermined period of time, that the touch sensors 12 and 13 are being touched (Step 304), then the user is again holding the portable electronic device 10 and the portable electronic device 10 will therefore remain in operating mode (Step 301).

While this invention has been described by way of examples and preferred embodiments above, it is to be understood that this invention is not limited thereto, and that various changes, substitutions and alterations can be made thereto without departing from the spirit and scope of this invention. The scope of the protection of this invention should therefore be based on the following appended claims.

What is claimed is:

1. A mobile phone which is switchable between a sleep mode and an operating mode, comprising:
a touch sensor configured to detect a touch on the mobile phone and generate a first signal in response to the touch;
an accelerometer configured to detect a gravitational acceleration of the mobile phone in a three dimensional space and generate a second signal in response to the gravitational acceleration;
a microcontroller unit coupled to the touch sensor and the accelerometer and configured to analyze the first signal and the second signal and to generate an interruption signal upon analyzing the first signal and the second signal;
a processing unit coupled to the microcontroller unit and configured for receiving the interruption signal; and
a display coupled to the processing unit, wherein the display is displaying information in the operating mode and turned off in the sleep mode;
wherein when the mobile phone is in the sleep mode, the processing unit switches the mobile phone from the sleep mode to the operating mode upon receiving the interruption signal.

2. The mobile phone according to claim 1, wherein when the mobile phone is in the operating mode, the processing unit switches the mobile phone form the operating mode to the sleep mode upon receiving the interruption signal.

3. The mobile phone according to claim 1, wherein the mobile phone consumes less power in the sleep mode than in the operating mode.

4. The mobile phone according to claim 1, wherein the accelerometer initiates the detection of the gravitational acceleration after analyzing the first signal.

5. The mobile phone according to claim 1, wherein the touch sensor is a capacitive touch sensor disposed at one side of the mobile phone.

6. The mobile phone according to claim 1, wherein the touch sensor is a capacitive touch sensor disposed at a surface opposite to the surface of the display.

7. The mobile phone according to claim 1, wherein after analyzing the first signal, the microcontroller unit is configured to analyze the second signal and to transmit the interruption signal upon analyzing of the second signal.

8. A mode switching method for a mobile phone having a display and being switchable between a sleep mode and an operating mode, the method comprising:
detecting a touch on the mobile phone;
generating a first signal in response to the touch;
detecting a gravitational acceleration of the mobile phone in a three dimensional space;
generating a second signal in response to the gravitational acceleration;
generating an interruption signal upon analyzing the first signal and the second signal; and
when the mobile phone is in the sleep mode with the display being turned off, switching the mobile phone from the sleep mode to the operating mode and display information on the display upon receiving the interruption signal.

9. The mode switching method for the mobile phone according to claim 8, wherein the mobile phone consumes less power in the sleep mode than in the operating mode.

10. The mode switching method for the mobile phone according to claim 8, further comprising the step of initiating the detection of the gravitational acceleration of the mobile phone in the three dimensional space after analyzing the first signal.

11. The mode switching method for the mobile phone according to claim 8, wherein the second signal includes a value of the gravitational acceleration and the method further comprises the steps of: determining whether the value falls within a first predetermined range; and switching the mobile phone to the operating mode when the value falls within the first predetermined range.

12. The mode switching method for the mobile phone according to claim 11, wherein the first predetermined range is the range corresponding to changes of the value when the mobile phone is being lifted.

13. The mode switching method for the mobile phone according to claim 8, further comprising the step of switching the mobile phone from the operating mode to the sleep mode and turned off the display upon receiving the interruption signal when the mobile phone is in the operating mode with the display displaying information.

14. The mode switching method for the mobile phone according to claim 13, wherein the second signal includes a value of the gravitational acceleration and the method further comprises the steps of: determining whether the value falls within a second predetermined range; and switching the mobile phone to the second mode when the value falls within the second predetermined range.

15. The mode switching method for the mobile phone according to claim 14, wherein the second predetermined range is the range corresponding to changes of the value when the mobile phone is being put down.
